(19) United States
(12) Patent Application Publication
(10) Pub. No.: US 2024/0241623 A1
(43) Pub. Date: Jul. 18, 2024

(54) METHOD AND MEASUREMENT SYSTEM FOR CARRYING OUT AND/OR DISPLAYING A MEASUREMENT PROCESS

(71) Applicant: MICRO-EPSILON MESSTECHNIK GMBH & CO. KG, Ortenburg (DE)

(72) Inventors: Hannes LOFERER, Ortenburg (DE); Andreas LIEBL, Vilshofen (DE); Thomas WISSPEINTNER, Ortenburg (DE)

(21) Appl. No.: 18/557,840

(22) PCT Filed: Mar. 9, 2022
(86) PCT No.: PCT/DE2022/200038

§ 371 Date: Oct. 27, 2023

(30) Foreign Application Priority Data
May 6, 2021 (DE) 10 2021 204 614.2

(51) Int. Cl. G06F 3/0484; G01B 11/24; G06F 3/0482

(52) U.S. Cl. CPC G06F 3/0484; G01B 11/24; G06F 3/0482

(57) ABSTRACT

A method for executing and/or displaying a measuring process by means of a measuring system, the measuring system comprising at least one computing device, at least one display device and at least one measuring means for metrologically sensing an item, the measuring process being controllable via the display device, comprising the following method steps: recording measured value data which are generated with the measuring means; generating object entities as entities with respect to the item to be metrologically sensed; generating combination entities as entities with respect to the item to be metrologically sensed; outputting relationships between the generated entities, the relationships being displayed for a predeterminable entity. Furthermore, a corresponding measuring system and computer program product are disclosed.

### CROSS REFERENCE

This application is a national stage entry application under 35 U.S.C. 371 of PCT Patent Application No. PCT/DE2022/200038, filed on 9 Mar. 2022, which claims priority to German Patent Application No. 10 2021 204 614.2, filed on 6 May 2021, the entire contents of each of which are incorporated herein by reference.

### FIELD

The disclosure relates to a method for executing and/or displaying a measuring process by means of a measuring system.

Furthermore, the disclosure relates to a corresponding measuring system for executing and/or displaying a measuring process. Finally, the disclosure relates to a corresponding computer program product.

### BACKGROUND

Methods and systems of the type in question have been known from practice for years. Accordingly, various products exist for the metrological sensing of objects, which can support the operator/user in executing and displaying a measuring process. This is usually done with the help of software.

Corresponding software packages face the challenge of presenting the entities managed by an application to a user in a meaningful way on the screen. For simple applications, a list display is sufficient. For example, for a list display, reference can be made to the file display in Windows Explorer, according to which a plurality of files of a folder are displayed as a list in the right part of a window (cf. FIG. 1). However, a particular disadvantage of this display according to FIG. 1 is that no dependencies or references between the entities can be displayed. All files in the window are independent from each other.

To stay with the Explorer example: The dependencies between the folders of a drive can also be displayed hierarchically as a tree structure in the left part of a displayed window. FIG. 2 shows an exemplary display of a plurality of folders in a hierarchical tree structure of a file manager in a schematic view.

Such displays in the form of a hierarchical tree structure are well suited if the entities to be displayed are in strict 1:n dependencies to each other:
1 folder can have n subfolders
1 folder can contain n files

However, the following also applies:
1 file can only be in one folder
1 subfolder has exactly one parent folder
Files have no relations to each other

If this is the case, a clear and intuitive display of the entities can be achieved by combining the tree structure on the left and the list on the right.

Due to the widespread use of the tree or list displays as a standard for displaying the contents of drives, these concepts have also found their way into other software applications. As long as the above conditions regarding 1:n dependency are met, this is a suitable choice.

However, especially in the area of software systems for the metrological sensing of objects, for example for geometry measurement or surface inspection, use cases are of importance where additional relationships have to be considered between the relevant entities. Known software systems are difficult to handle, confusing and complicated for the user.

### SUMMARY

The present disclosure is therefore based on the object of designing and refining a method and a measuring system for executing and/or displaying a measuring process in such a way that simple handling and the most efficient possible verification of the measuring process are possible for the user.

According to the disclosure, the aforementioned object may be achieved by the features of claim 1. Accordingly, a method for executing and/or displaying a measuring process by means of a measuring system is provided, the measuring system comprising at least one computing device, at least one display device, and at least one measuring means for metrological sensing of an item, the measuring process being controllable via the display device, comprising the following method steps:
recording measured value data generated with the measuring means,
generating object entities as entities with respect to the item to be sensed metrologically,
generating combination entities as entities with respect to the item to be sensed metrologically,
outputting relationships between the generated entities, the relationships being displayed for a specifiable entity.

Furthermore, the aforementioned object may be achieved by the features of claim 15. Accordingly, a measuring system for executing and/or displaying a measuring process is provided, the measuring system comprising at least one computing device, at least one display device, and at least one measuring means for metrological sensing of an item, the measuring process being controllable via the display device, wherein the measuring system is designed in such a way that:
that measured value data generated with the measuring means can be recorded,
object entities can be generated as entities with respect to the item to be sensed metrologically,
combination entities can be generated as entities with respect to the item to be sensed metrologically, and
relationships between the generated entities are output, in an embodiment via the display device, it being possible for the relationships for a predeterminable entity to be displayed.

Finally, the foregoing object may be achieved by the features of claim 16 concerning a computer program product.

In accordance with the disclosure, it has first been recognized that simple handling and the most efficient possible verification of the measuring process for the user can be realized by allowing the measuring process to be controlled via a display device. The measuring process is executed and/or displayed with a measuring system comprising at least one computing device, at least one display device and at least one measuring means for metrological sensing of an item. In a method according to the disclosure, measured value data generated by a measuring means is first recorded. Optionally, the measured value data can then be subjected to data pre-processing.

Furthermore, according to the disclosure, it has been found that the control and verification of calculations within the measuring process can be greatly simplified and made efficient for the user by grouping different types of entities. Entities can be determined via the display device in relation to the item to be metrologically sensed. The entities comprise object entities as a first entity type and combination entities as a second entity type. According to the disclosure, object entities are thus determined/generated as entities with respect to the item to be metrologically sensed, and the object entities may be combined in a first group. Furthermore, combination entities are determined/generated as entities with respect to the item to be metrologically sensed, and the combination entities may be combined in a second group. Combination entities are based on a plurality of object entities so that various calculations and analyses can be executed with respect to the item to be sensed metrologically. Finally, with regard to a clear and efficient verification of generated analysis and calculation results, it is envisaged that existing relationships between the generated entities are displayed via the display device. This provides an efficient and clear consistency check for the user in a sophisticated way. In an embodiment, a visualization of the assignment of entities that are in an n:m connection to each other can be provided in an advantageous way. The user stays on top of things and is provided with an effective process flow control for the measuring process.

Consequently, with the method according to the disclosure and the measuring system according to the disclosure, the user is provided with improved handling with regard to the measuring process performance and the most efficient verification of the measuring process.

At this point, it should be noted that the term “entity”—particularly in the context of the claims and preferably in the context of the description—can be understood to mean a charac-teristic property relating to an item and/or its metrological sensing. Entities can be, for example, parameters or parameter data relating to the item and/or its metrological sensing. Furthermore, entities can thus represent, for example, a feature, in particular a metrologically sensed and/or geometric feature, with respect to an item.

With regard to the term “object entity”, it should be noted,—particularly in the context of the claims and preferably in the context of the description—that object entity can be understood to mean one or more properties characterizing the item with regard to the measurement task.

With regard to the term “combination entity”, it should be noted—particularly in the context of the claims and preferably in the context of the description—that a combination entity can be understood to mean a combination of object identities, their relation to each other or the result of this relation with the object entities can be understood as an input variable.

Advantageously, a combination entity may be based on a plurality of entities such that the combination entity uses a plurality of entities as input entities. An input entity can be an already generated or already determined (optionally geometric) object entity or an already generated or already determined combination entity.

In a further advantageous manner, the combination entities may represent evaluation operations, wherein a plurality of entities are combined to determine the evaluation operations. The a plurality of entities are each used herein as an input entity for the combination entity in order to calculate—based on the objects already present or on parameter data provided by them—results for the evaluation operations.

In an advantageous configuration, a (e.g., average) temperature, a temperature dis-tribution, a color, a color index, a distance, a velocity, an acceleration, a plane, an area, a normal vector and/or an edge can be determined as an object entity with respect to the item to be metrologically sensed (or measured). Thus, various properties of an item to be measured can be sensed metrologically in an effective and efficient manner and can be used for subsequent analysis and calculation of properties of the item to be measured.

In an advantageous configuration, edges, planes, areas, circles, spheres, lines and/or centroids, for example, can be determined as object entities in relation to the item to be measured. Thus, the object entities can be, for example, geometric entities with respect to the item. Thus, various surfaces of an item to be measured can be imaged in an effective and efficient manner and can be used for subsequent analysis and calculation of properties of the item to be measured.

In an advantageous configuration, as a combination entity, a combination of object entities, their relation to each other and/or the result of this relation with the object entities can be determined as an input variable with respect to the item to be metrologically sensed (or measured). The combination entities can advantageously access already generated object entities and use these object entities or their parameter data as input data. Thus, various calculations, analyses and evaluations can be executed efficiently by combining object entities.

In an advantageous configuration, angles, distances and/or sections, for example, can be determined as combination entities with respect to the item to be measured. The combination entities can advantageously access already generated object entities and use these object entities or their parameter data as input data. Thus, various calculations can be executed efficiently by combining object entities.

In an advantageous configuration, the object entities can be displayed in a first grouping and the combination entities can be displayed in a (e.g., separate) further grouping via the display device. Thus, grouping of different entity types can be done, which allows a user to visualize different entities in the most structured way possible.

Advantageously, it is conceivable that relationships are displayed for a predeterminable entity, provided that the predeterminable entity is selected. This provides an efficient and clear consistency check for the user in a sophisticated way. Furthermore, it would be conceivable that the relationships are not displayed constantly, but only when the predeterminable entity is selected (e.g. by mouseover and/or clicking). Furthermore, it could be implemented that the relationships for a predeterminable entity are displayed for a predefined, optionally settable, period of time. Finally, the relationships for the predeterminable entity could be represented as long as the predeterminable entity remains selected.

In an advantageous configuration, relationships for a predeterminable entity can be displayed by means of displayable graphical pointing elements. This can be done in an advantageous way when the predeterminable entity is selected. Thus, the relationships between generated entities can be output, for example, via a graphical user interface of the display device, where the relationships are visualized, for example, only when the predeterminable entity is selected.

In an advantageous configuration, the display device may comprise an output element, wherein the output element may comprise a list, table, file, or generally a data stream con-taining the relationships between the entities as presented. It is advantageous if the display device has a graphical user interface to display the relationships via any output elements.

In an advantageous configuration, the display device may comprise an input element, wherein the input element may comprise a list, table file, or generally a data stream, by means of which the measuring process can be controlled. It is advantageous if the display device has a graphical user interface to control the measuring process via any input elements.

In an advantageous configuration, the display device may comprise a relationship element, wherein the relationship element may comprise a list, table, file, or generally a data stream where the relationship between the entities is displayed. It is advantageous if the relationship between the entities is displayed on a graphical user interface of the display device, for instance via displayable, graphical pointing elements.

In an advantageous configuration, the displayable graphic pointing elements may comprise lines, pointers, and/or arrows. In the context of an advantageous configuration, a displayable pointing element can also be understood to mean a graphic highlighting of an already existing element, for example by flashing, color or shape change. It is conceivable that an already existing pointing element can be highlighted and/or that already generated or displayed entities (object and/or combination entities) can be highlighted. This provides a user with a particularly simple, effective and efficient way of checking existing relationships, for instance calculation relationships, for correctness or consistency.

In an advantageous configuration, when an object entity is selected, the graphical pointing elements can visualize/show links to entities that use the selected object entity. Thus, an efficient verification or control of any relationships between the entities is implemented.

In an advantageous configuration, when a combination entity is selected, the graphical pointing elements can visualize/show links to those entities that are used as input by the selected combination entity. Thus, an efficient verification or control of any relationships between the entities is implemented.

In an advantageous configuration, grouping of entities may be performed using graphical elements, for example in tabular format or list display.

In an advantageous configuration, entities, preferably within a grouping, can be selected by mouseover, by clicking and/or by key navigation, preferably by cursor keys. This imple-ments a fast and efficient navigation for the user.

In an advantageous configuration, when an entity is selected, an associated property field may be displayed. The property field can be used to make adjustments and, optionally, further settings.

In an advantageous configuration, the measuring means may be designed to measure distances, positions, geometries, colors and/or temperatures. Advantageously, the measuring means of the measuring system may comprise an optical measuring means. For example, a laser distance sensor, a laser profile sensor, and/or a camera may be provided as an optical measuring means. Furthermore, a distance sensor, a position sensor, a geometry sensor, a color sensor and/or a temperature sensor are conceivable as a measuring means for the measuring system. Thus, a wide variety of metrological acquisitions of the item can be implemented and can be performed and displayed in the context of embodiments of the disclosure.

Now, there are various possibilities for advantageously configuring and refining the teaching of the present disclosure. For this purpose, reference is made on the one hand to the claims subordinate to claim 1 and on the other hand to the following explanation of exemplary embodiments of the disclosure with reference to the drawings. In conjunction with the explanation of the exemplary embodiments of the disclosure with reference to the drawing, generally preferred configurations and refinements of the teaching are also explained.

### BRIEF DESCRIPTION OF THE SEVERAL VIEWS OF THE DRAWINGS

FIG. 1 shows a schematic view of an exemplary display of multiple files in a list display of a file manager,

FIG. 2 shows an exemplary display of a plurality of folders in a hierarchical tree structure of a file manager in a schematic view,

FIG. 3 shows an example to illustrate relationships between two different types of entities in a schematic display,

FIG. 4 shows a display of two different types of entities in a tree structure in a schematic view,

FIG. 5 shows the display shown in FIG. 4, with a dialog display added to display further information, in a schematic view,

FIG. 6 shows a graphical user interface of a display device according to an exemplary embodiment of the disclosure in a schematic view,

FIG. 7 shows an exemplary embodiment of a method according to the disclosure, wherein a measuring process for measuring a surface of an object is executed and visualized, in a schematic view,

FIG. 8 shows a graphical user interface of a display device according to an exemplary embodiment of the disclosure in a schematic view,

FIG. 9 shows a measuring process flow according to an exemplary embodiment of a method according to the disclosure in a schematic view,

FIG. 10 shows the graphical user interface of a display device according to an exemplary embodiment of the disclosure in a schematic view,

FIG. 11 shows the graphical user interface of a display device according to an exemplary embodiment of the disclosure in a schematic view,

FIG. 12 shows the graphical user interface of a display device according to an exemplary embodiment of the disclosure in a schematic view,

FIG. 13 shows the graphical user interface of a display device according to an exemplary embodiment of the disclosure in a schematic view,

FIG. 14 shows a measuring process flow according to an exemplary embodiment of a method according to the disclosure in a schematic view,

FIG. 15 shows the graphical user interface of a display device according to an exemplary embodiment of the disclosure in a schematic view, and

FIG. 16 shows the graphical user interface of a display device according to an exemplary embodiment of the disclosure in a schematic view.

### DETAILED DESCRIPTION OF THE DISCLOSURE

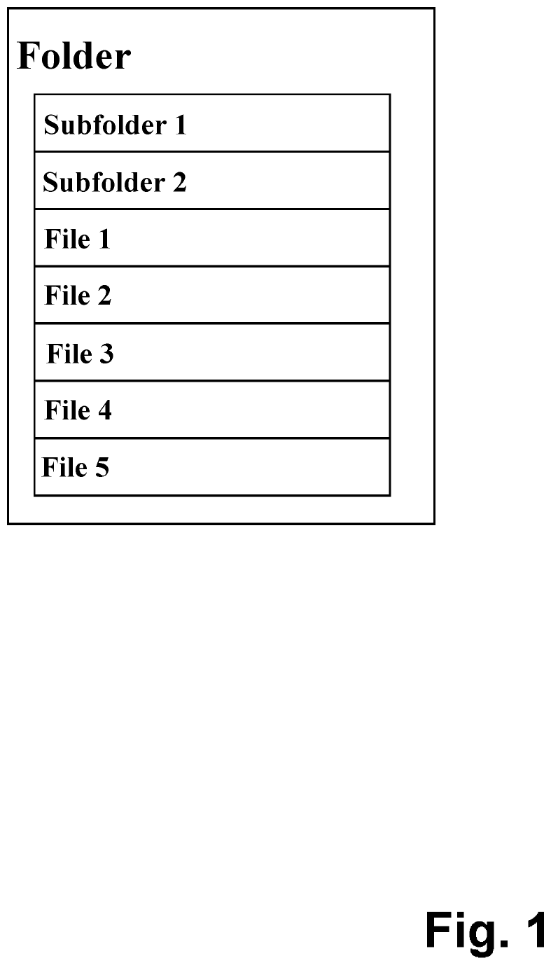

FIG. 1 shows an exemplary display of multiple files in a list display of a file manager in a schematic view. Many software packages face the challenge of displaying the entities managed by an application to a user in a meaningful way on the screen. For simple applications, a list display is sufficient. For example, reference can be made to the file display in Windows Explorer, according to which n files of a folder are displayed as a list in the right part of a window (cf. FIG. 1).

A disadvantage of this display according to FIG. 1 is that no dependencies or references between the entities can be displayed. All files in the window are independent from each other.

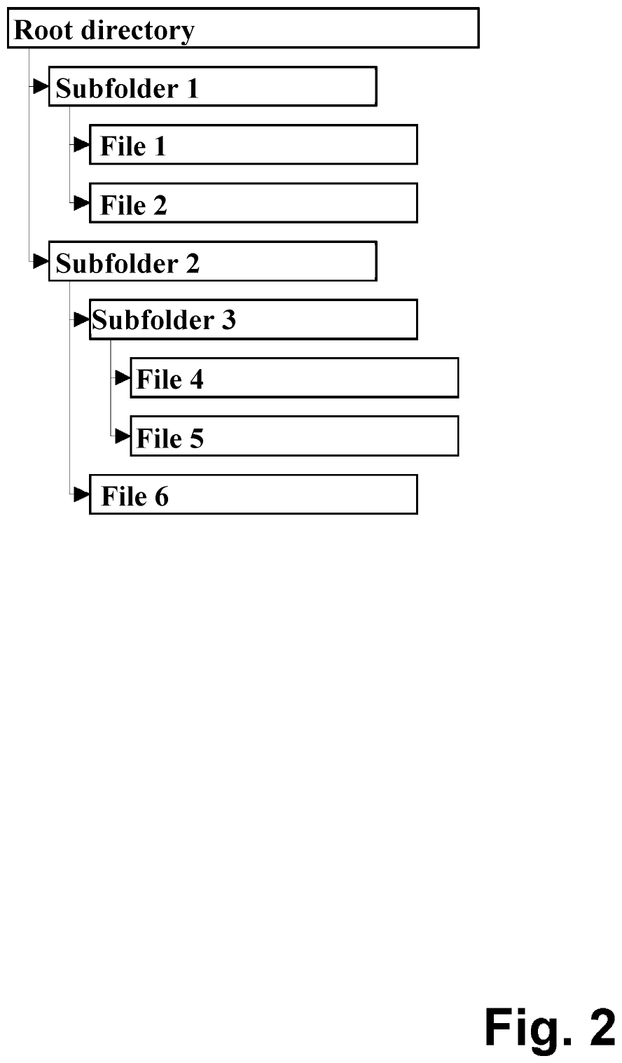

To stay with the Explorer example: the dependencies between the folders of a drive can be displayed hierarchically as a tree structure in the left part of the displayed window. FIG. 2 shows an exemplary display of a plurality of folders in a hierarchical tree structure of a file manager in a schematic view.

Such displays in the form of a hierarchical tree structure are well suited if the entities to be displayed are in strict 1:n dependencies to each other:
1 folder can have n subfolders
1 folder can contain n files

But:
1 file can only be in one folder
1 subfolder has exactly one parent folder
Files have no relations to each other

In the case of such 1:n dependencies, a clear and intuitive display of the entities can be achieved by combining the tree structure on the left and the list on the right.

Due to the widespread use of the tree or list displays as a standard for displaying the contents of drives, these concepts have also found their way into other software packages. As long as the above conditions regarding 1:n dependency are met, this is a suitable choice.

However, there are software packages where there are additional relationships to manage between entities.

For example, in the context of an exemplary embodiment of the disclosure, two different types of entities are to be considered, with additional relationships to be managed between the entities. It is thus nom dependencies between two different types of entities, namely “objects” as object entities and “combinations” as combination entities:
Combinations can use a plurality of objects as inputs;
Objects can serve as inputs for a plurality of combinations or other objects;
Combinations can serve as inputs for other combinations;

In the context of an exemplary embodiment of the disclosure, objects can be measured using an optical measuring means in order to calculate distances, angles, sections, etc.

Examples of objects for the use case in metrology can be:
plane
ball
line
centroid

Examples of combinations for the use case in metrology can be:
angle
distance
section

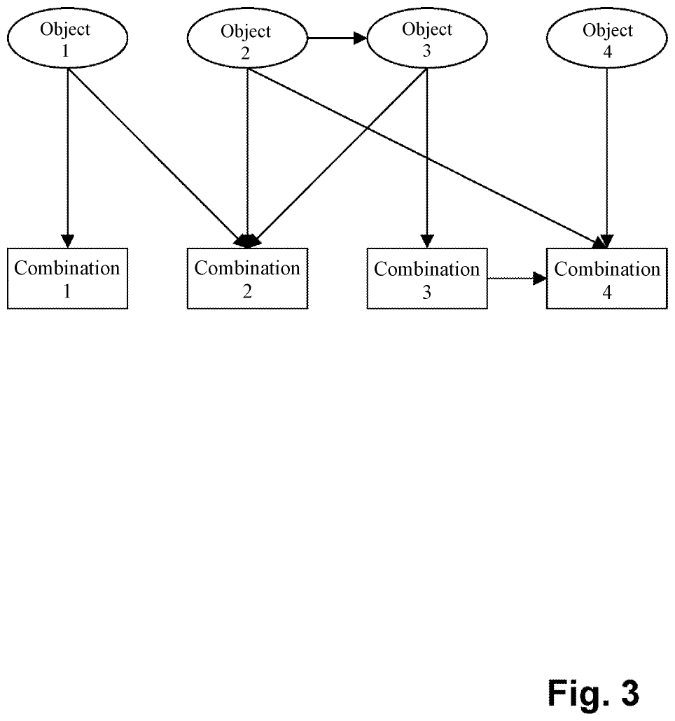

FIG. 3 shows an example to illustrate relationships between two different types of entities, objects and combinations, in a schematic display, It is important for the operator/user to be able to quickly capture the appropriate dependencies between objects and check for correct-ness/consistency. This requires a suitable display. As can be seen from the diagram depicted in FIG. 3, it is generally challenging to indicate relationships between two entity types. In more complex scenarios, this quickly becomes confusing.

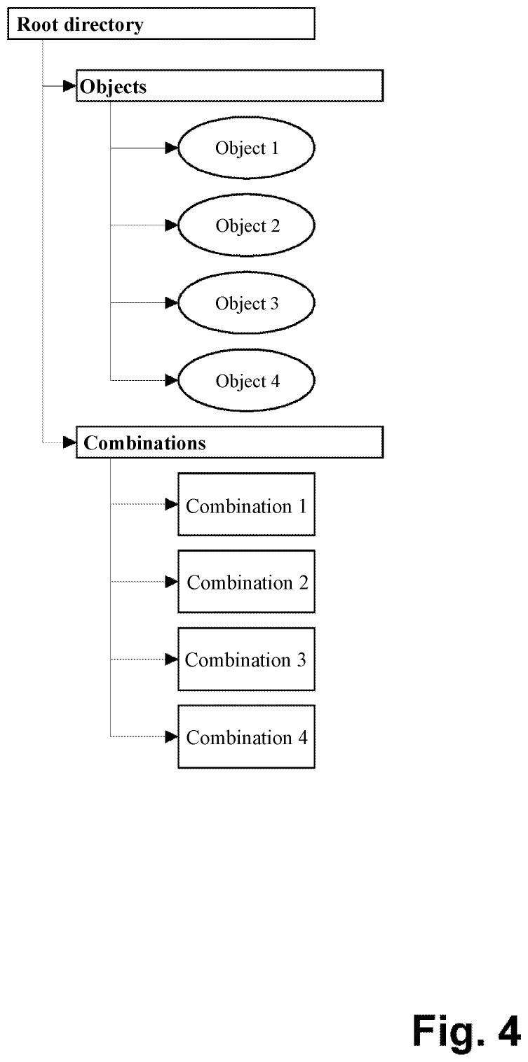

A familiar approach is to display the two entities in two subfolders of a tree structure, as illustrated in FIG. 4. However, the display of the relationships between the objects is not possible in the tree structure according to FIG. 4.

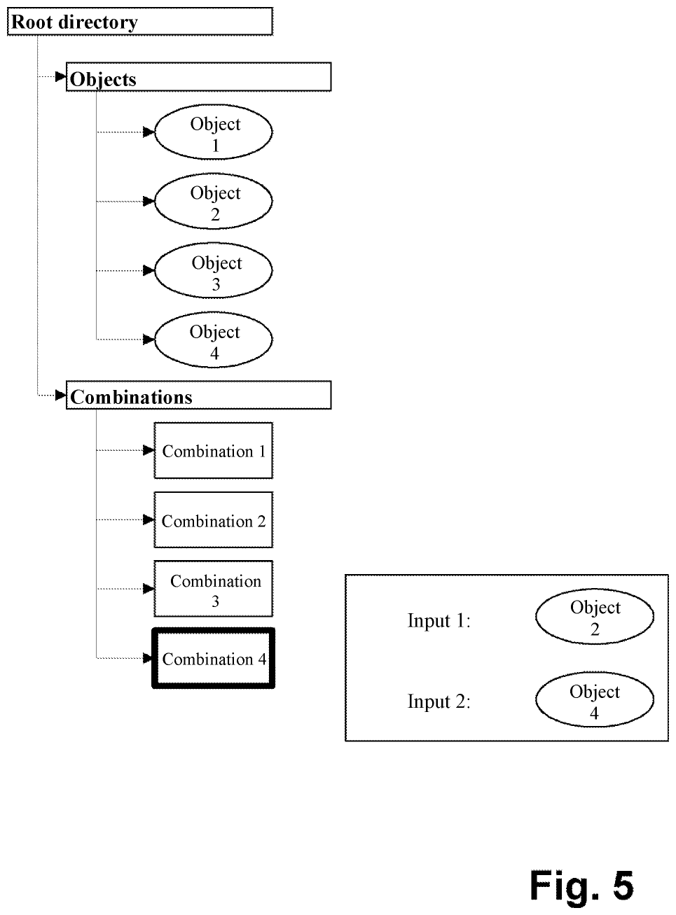

Therefore it is conceivable to display a dialog with the overview of the input objects used when selecting an entity. This is illustrated in FIG. 5. FIG. 5 shows the display shown in FIG. 4, with a dialog display added to display further information, in a schematic view,

The approach according to FIG. 4 has the disadvantage that a check of the links between the entities can only be done by their names. For a consistency check, particular care must be taken to give each entity a unique and meaningful name. A complete consistency check requires that the respective dialogs for all entities are opened one after the other. This is quite laborious and inconvenient.

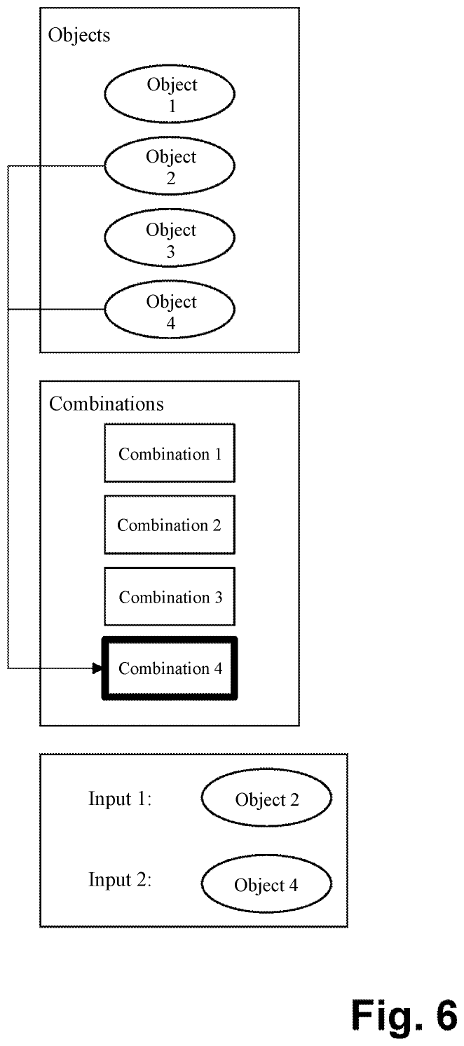

FIG. 6 shows a graphical user interface of a display device according to an exemplary embodiment of the disclosure in a schematic view, Accordingly, an effective process flow control for the measuring process is made possible by a computer program, wherein a visualization of the assignment of entities of the computer program takes place, which can have an n:m relation to each other. For the user to keep track in this application, the following implementations have been chosen:
objects are displayed in a simple list;
combinations are displayed in a second list;
relationships between the two types of entities (objects, combinations) are indicated by graphical pointing elements (e.g. arrows, lines or pointers), which are not displayed all the time, but only when an entity is selected (mouseover, or clicked);
when selecting an object: graphic pointing elements (arrows) are displayed to show links to the combinations in which the object is used;
when a combination is selected: graphical pointer elements (arrows) are displayed to show links to the objects or combinations used as inputs by the selected combination;
in addition, the properties field for the selected element or entity is displayed in each case, in which, optionally, adjustments can be made.

This offers several advantages:
Only the links for an entity that is currently being viewed (mouseover) or selected (click) are displayed. In the example according to FIG. 6, this relates to combination 4, which has object 2 and object 4 as inputs. This maintains clarity and allows the user to efficiently verify the measuring process.
The lists of entities can be scrolled through by cursor keys. This allows for a quick complete inspection.
In addition to the names of the entities, their position in the respective list is also displayed at the link (e.g. Input 1, Input 2). This allows efficient verification by the user even if the name is not meaningful.

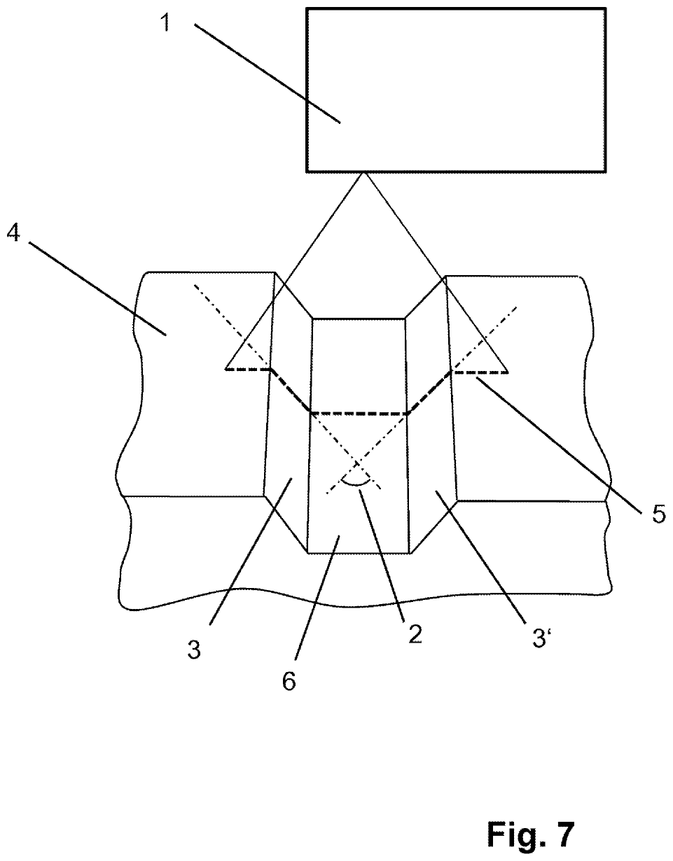

FIG. 7 shows an exemplary embodiment of a method according to the disclosure, wherein a measuring process for measuring a surface of an item is executed and visualized, in a schematic view. Specifically, an exemplary embodiment of the disclosure is described using an example from metrology: a laser profile sensor (1) is used to measure the angle (2) between two areas (3, 3′) on the surface of an item (4). The laser profile sensor (1) generates a laser line (5) that is projected onto the item (4). The laser line (5) is imaged onto an image receiver (for example a CCD camera) in the profile sensor (1) via receiving optics. When the laser profile sensor (1) is moved over the item (4), an image of the surface can be generated by stringing together the measured profiles. In the example shown in FIG. 7, this is a V-shaped groove (6) in a workpiece. The angle (2) between the two flanks (3, 3′) of the groove (6) is to be determined.

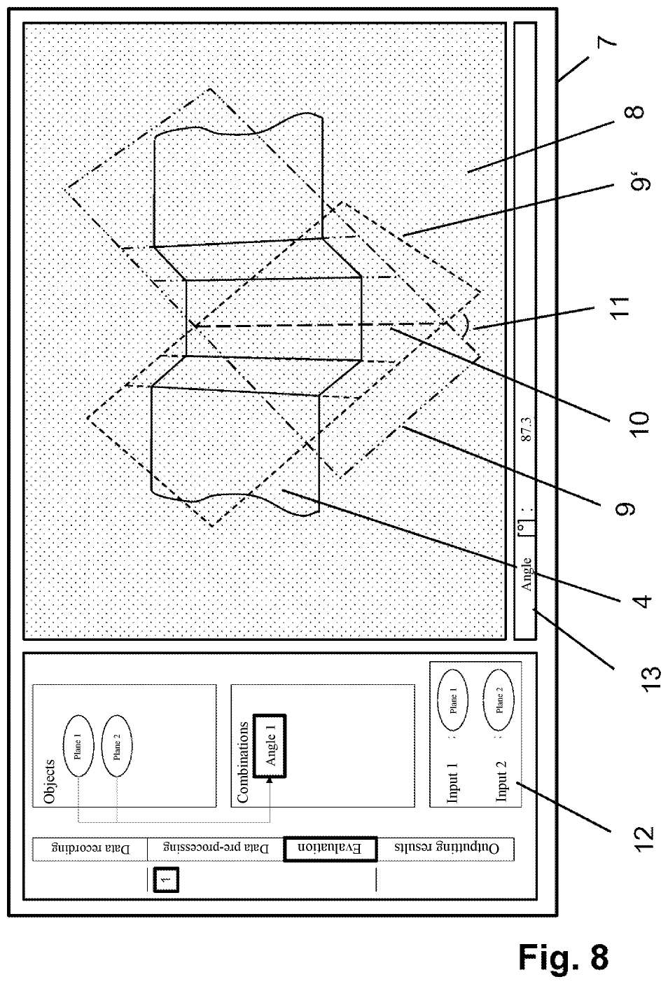

FIG. 8 shows a graphical user interface of a display device according to an exemplary embodiment of the disclosure in a schematic view. Specifically, FIG. 8 shows a graphical user interface of a software package for executing a method according to an exemplary embodiment of the disclosure, which is used for visualization and evaluation of measurement data. In the main window (7) of the program there is a pictorial display of the item (4) to be measured in a visualization box (8) for visualization. The measured values (the point cloud is not shown for clarity) are used to generate the planes (9, 9′) representing the two flanks (3,3′) of the groove (6) in the workpiece.′ In the section line (10) between the two planes (9, 9′), the angle (11) between the planes is shown, representing the angle (2) between the two flanks.

Furthermore, FIG. 8 shows a menu box (12) that controls the process flow of the measuring process and—using the example of an evaluation phase—shows the objects, their combinations and their properties.

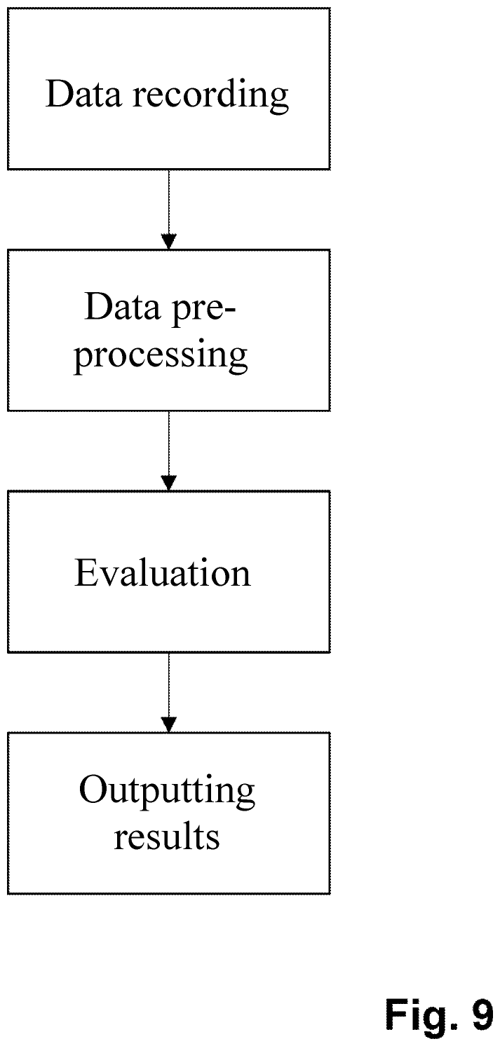

FIG. 9 shows a measuring process flow according to an exemplary embodiment of a method according to the disclosure in a schematic view. The measuring process in the context of the exemplary embodiment may initially comprise four process phases in general: data acquisition, data pre-processing, evaluation and result output.

As part of the data acquisition process, a computer program is first used to establish a link to an optical measuring device or a sensor via a suitable interface and—after setting the measurement parameters—measurements are performed. The measured values generated by the sensor (in the case of 3D sensors, these are usually point clouds, i.e. measurement points in a suitable coordinate system) can then be fed into the computer program.

In a phase of data pre-processing, the (original or optionally already pre-processed in the sensor) measured values can be processed. This can be, for example, the correction of the mounting position or the (dynamic) alignment of the measured object (dynamic component alignment). Conceivable here is, for example, a transformation of the coordinate system of the measurement object or the sensor into another, for example into a global coordinate system. Data pre-processing may also comprise filtering of the measured values and/or selection of the desired measured values (region of interest).

In the subsequent phase of evaluation, objects (such as edges, planes, spheres, circles, etc.) can be determined as well as combinations of these objects, namely the desired evaluation operations (for example, distances, angles, sections, etc.).

Finally, the results of the evaluation operations are output as results (measured values, limit values, etc.).

In order to communicate the execution of the measuring process efficiently and quickly to the operator, this process flow is clearly displayed by the computer program in the menu box (12) on the graphical user interface of the display unit. Depending on the selected step in the measuring process flow, the displayed selection lists and property fields can be adjusted.

In the context of an exemplary process flow for an evaluation phase, this is presented as follows:

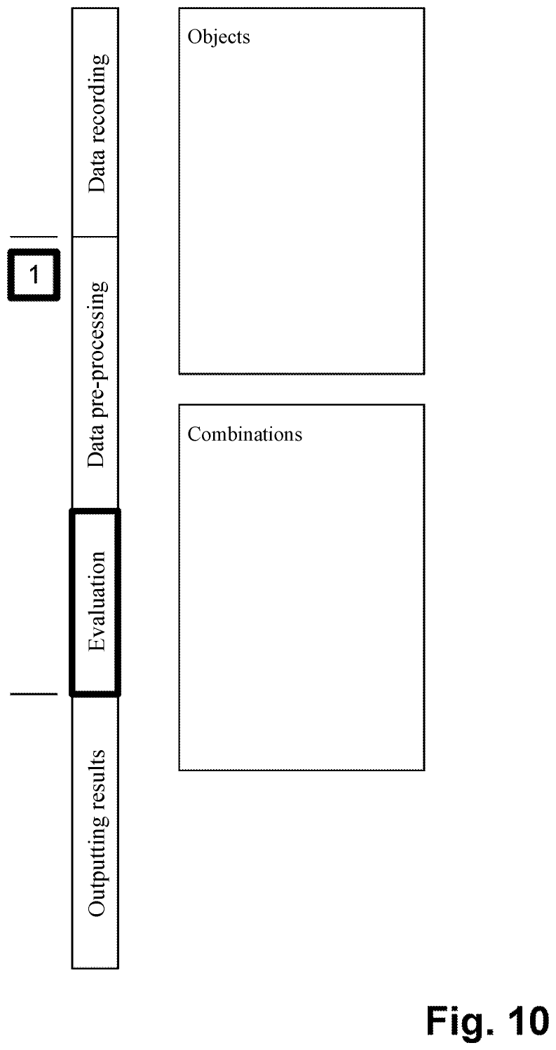

Initially, the areas in the list display for objects and combinations are empty, as shown in FIG. 10 in a schematic view for the graphical user interface.

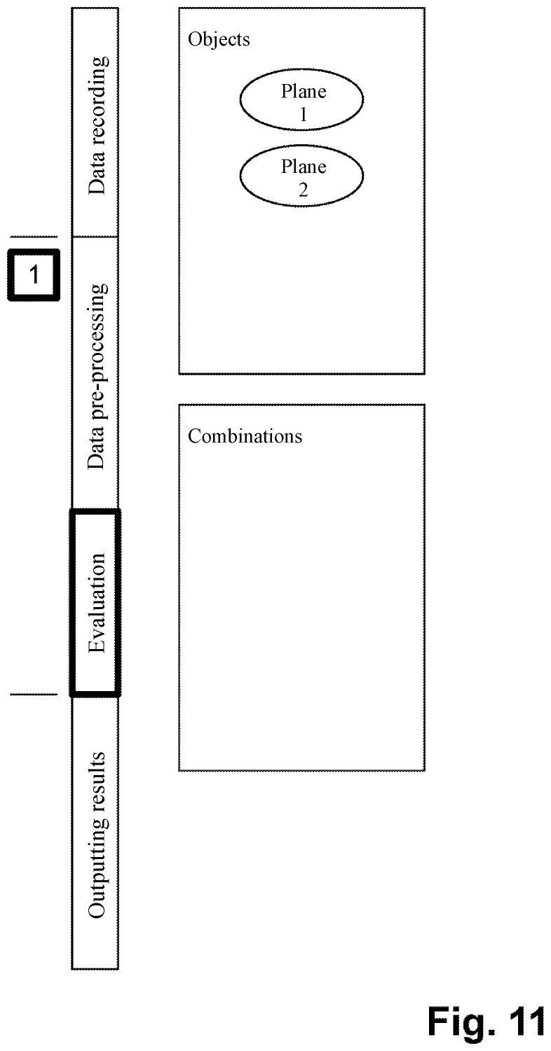

As shown in FIG. 11, the two objects (“Plane 1” and “Plane 2” as object entity in FIG. 11) are then first created for the extraction of the planes and parameterized accordingly.

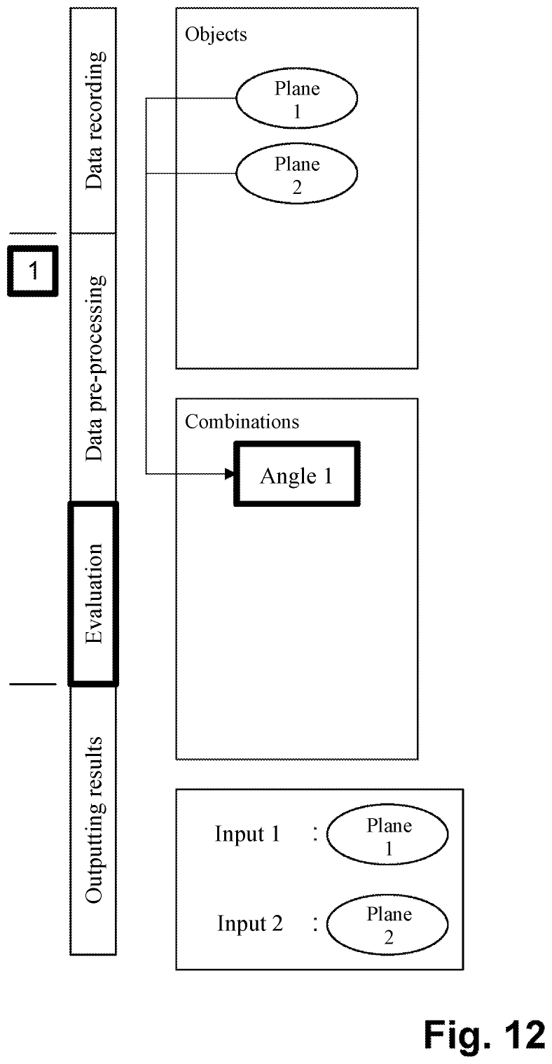

Then a combination “angle” is created and linked to the two previously created objects “Plane 1” and “Plane 2” as inputs (cf. FIG. 12).

This completes the setup and the angle between the planes can be calculated and output.

If the combination “Angle 1” is selected (e.g. by mouseover or clicking) specifically, pointing elements are displayed, which show the selected inputs (i.e. the objects) for the combination. Additionally, the properties of the objects are displayed in a separate box. “Input 1” corre-sponds to “Plane 1” and “Input 2” to “Plane 2”, which are used to calculate the angle “Angle 1” (i.e. the combination of object 1 and object 2).

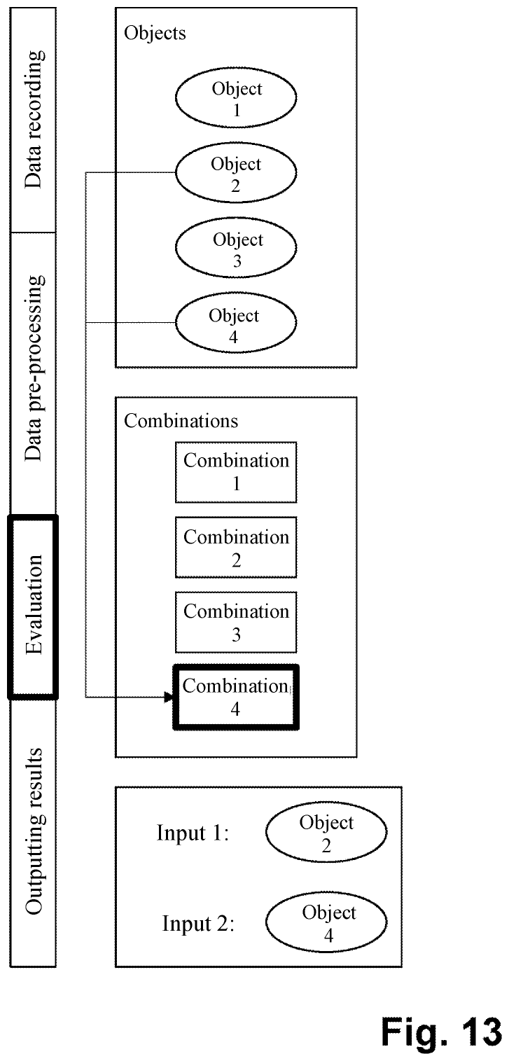

FIG. 13 shows a graphical user interface of the display device according to an exemplary embodiment of the disclosure in a schematic view, wherein, in particular in the case of more complex evaluations with multiple combinations, the respective associated objects and their properties are displayed when the respective combination is selected.

As a rule it has been defined here that in each step or in each phase of the measuring process only results of calculations can be used which are above the current step or before the current phase. Combinations can only access objects and combinations that are above or have already been generated.

Furthermore, in order to support quick consistency checks, it is provided for giving immediate feedback on the corresponding input data and the respective intermediate result in a result box that when an object or a combination is selected. In the example according to FIG. 8, the value for the angle (11) is output in the result box (13). For more complex calculations, multiple intermediate steps and results can also be displayed here.

In principle, only those objects or combinations for other combinations can be used as inputs in the process flow whose results have already been calculated in the current measuring cycle. Accordingly, it is provided that a strict process flow without feedback must be adhered to.

The strict process flow means that the steps or phases “data pre-processing” and “evaluation” are always executed in this order. To allow now nevertheless also pre-processing modules with data of an object as input, the possibility is implemented that multiple blocks of pre-processing/evaluation can be managed. This allows the operator to set up, for example, the alignment of a point cloud to a plane previously extracted from the data. It also allows the task to be broken down into manageable blocks.

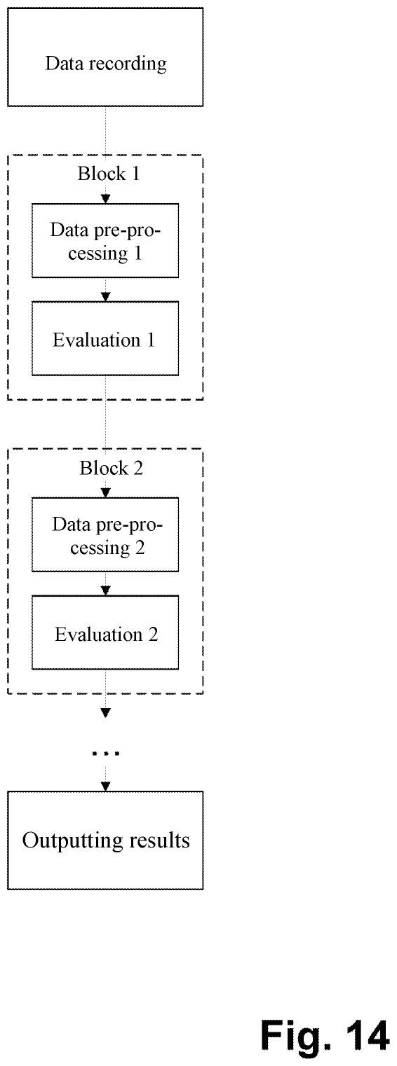

For example, additional blocks can be generated that also contain the steps/phases “Data processing” and “Evaluation”. For this purpose, reference is made to FIG. 14, which illus-trates in a schematic view a process flow of a measuring process according to an exemplary embodiment of a method according to the disclosure.

By creating a second block, which also contains the steps/phases “Data processing” and “Evaluation”, it is thus possible to access objects in the area “Data pre-processing 2”, which have been extracted from the data in the area “Evaluation 1”.

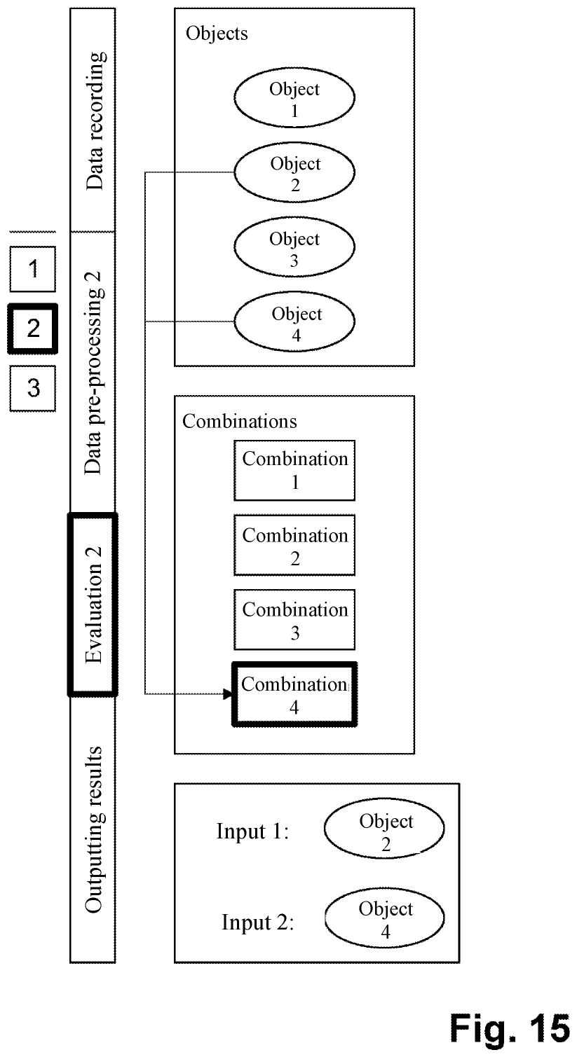

This is shown in the menu box (12) in such a way that the blocks are displayed next to the flowchart, with the active block highlighted (cf. FIG. 15).

Access to objects or combinations of previous blocks is thus possible and is displayed by a corresponding reference. In the example according to FIG. 14 or FIG. 15, results from “Block 1” are accessed in “Block 2” of “Pre-processing 2”.

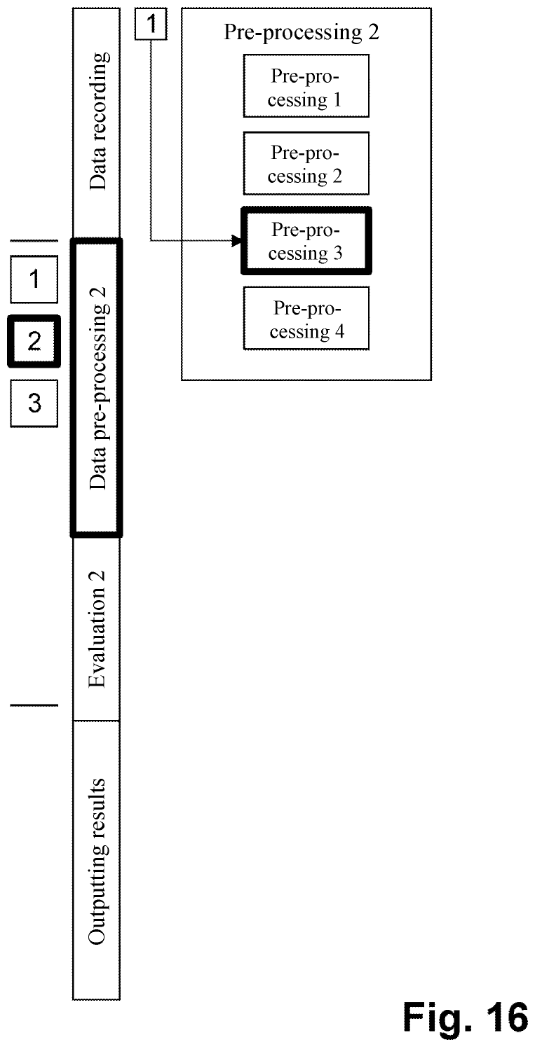

In the context of an exemplary embodiment, this may be indicated to the operator on the graphical user interface by a pointing element pointing to an icon representing block 1. In FIG. 16, the pointing element from “Pre-processing 3” points to the box labelled 1 representing the block 1.

Clicking on the displayed link to the parent block “1” immediately selects it and the display switches to Block 1, which then displays the selected entity. Accordingly, objects from block 1 are accessed in block 2 (pre-processing 2), i.e. objects from block 1 are used in block 2 for further processing.

To avoid repetition with regard to further advantageous configurations of the process according to the disclosure and of the measuring system according to the disclosure, reference is made to the general section of the description and to the appended claims.

Finally, it should be expressly noted that the above-described exemplary embodiments of the process according to the disclosure and of the measuring according to the disclosure are used solely to explain the claimed teaching without limiting it to the exemplary embodiments.

### LIST OF REFERENCE NUMERALS

1 Laser profile sensor
2 Angle
3, 3′ Area
4 Item
5 Laser line
6 V-shaped groove
7 Main window
8 Visualization box
9 Plane
10 Section line
11 Angle
12 Menu box
13 Results box

1. A method for executing and/or displaying a measuring process by means of a measuring system, the measuring system comprising at least one computing device, at least one display device, and at least one measuring means for metrological sensing of an item, the measuring process being controllable via the display device, comprising the following steps:
recording measured value data generated with the measuring means;
generating object entities as entities with respect to the item to be sensed metrologically;
generating combination entities as entities with respect to the item to be sensed metrologically,
outputting relationships between the generated entities, the relationships being displayed for a specifiable entity.

2. The method according to claim 1, wherein a combination entity is based on a plurality of entities in such a way that the combination entity uses a plurality of entities as input entities, wherein an input entity is an object entity or a combination entity.

3. The method according to claim 1 wherein the combination entities represent evaluation operations, wherein a plurality of entities are combined to determine the evaluation operations.

4. The method according to claim 1, wherein edges, planes, circles, spheres, lines, and/or centroids are determined as object entities with respect to the item to be measured.

5. The method according to claim 1, wherein angles, distances and/or sections are determined as combination entities with respect to the item to be measured.

6. The method according to claim 1, wherein the object entities are displayed in a first grouping via the display device, and wherein the combination entities are displayed in a second grouping via the display device.

7. The method according to claim 1, wherein relationships are displayed for a specifiable entity if the specifiable entity is selected.

8. The method according to claim 6, wherein relationships for a specifiable entity, upon selection of the specifiable entity, are displayed by means of displayable, graphical pointing elements.

9. The method according to claim 8, wherein the graphical pointing elements comprise lines, pointers, and/or arrows.

10. The method according to claim 8, wherein, when an object entity is selected, the graphical pointing elements visualize links to the entities that use the selected object entity.

11. The method according to claim 8, wherein, when a combination entity is selected, the graphical pointing elements visualize links to the entities used as input by the selected combination entity.

12. The method according to claim 1, wherein entities are selected by mouseover, by clicking, and/or by key navigation, preferably by cursor keys.

13. The method according to claim 1 wherein an associated property field is displayed when an entity is selected.

14. The method according to claim 1, wherein the measuring means is designed for measuring distances, positions, geometries, colors, and/or temperatures, and/or
wherein the measuring means comprises an optical measuring means, a laser distance sensor, a laser profile sensor, a camera, a distance sensor, a position sensor, a geometry sensor, a color sensor, and/or a temperature sensor.

15. A measuring system for executing and/or displaying a measuring process, for executing a method according to claim 1, the measuring system comprising at least one computing device, at least one display device, and at least one measuring means for metrological sensing of an item, the measuring process being controllable via the display device, wherein the measuring system is designed in such a way that:
that measured value data generated with the measuring means can be recorded,
object entities can be generated as entities with respect to the item to be sensed metrologically,
combination entities can be generated as entities with respect to the item to be sensed metrologically, and
relationships between the generated entities are output, in particular via the display device, it being possible for the relationships for a specifiable entity to be displayed.

16. A computer program product comprising program code stored on a machine-readable medium and providing and/or executing a method for executing and/or displaying a measuring process by means of a measuring system according to claim 1.
